(19) United States
(12) Patent Application Publication
(10) Pub. No.: US 2023/0113194 A1
(43) Pub. Date: Apr. 13, 2023

(54) Thermochemical method for storing and releasing thermal energy

(71) Applicants: ORANO CHIMIE-ENRICHISSEMENT, Châtillon (FR); CENTRE NATIONAL DE LA RECHERCHE SCIENTIFIQUE, Paris Cedex 16 (FR); UNIVERSITE DE LILLE, Lille (FR); ECOLE NATIONALE SUPERIEURE DE CHIMIE DE LILLE, Villeneuve d'Ascq Cedex (FR)

(72) Inventors: Artem Belonosov, Lille (FR); Murielle Rivenet, Baisieux (FR); Julien Rey, Limoges (FR); Gérald Senentz, Sèvres (FR); Bertrand Morel, Avon (FR); Augustin Dumas, Paris (FR)

(21) Appl. No.: 17/904,627

(22) PCT Filed: Feb. 23, 2021
(86) PCT No.: PCT/FR2021/050310

§ 371 Date: Aug. 19, 2022

(30) Foreign Application Priority Data
Feb. 25, 2020 (FR) 2001847

(51) Int. Cl. F28D 20/00; C01F 17/206

(52) U.S. Cl. CPC F28D 20/003; C01F 17/206; F28D 2021/0054

(57) ABSTRACT

A thermochemical method for storing and releasing thermal energy by means of a compound in solid form of formula AOₓB_{y}.zH₂O, in which: A is an element selected from uranium (U) and thorium (Th); O is the element oxygen; B is an anion or an oxoanion; x is a number comprised between 0 and 4; y is a number comprised between 0 and 2; z is a number greater than 0 and less than 10; it being understood that at least one of x and y is different from 0 and that the compound of formula Th(SO₄)₂.xH₂O is excluded.

### TECHNICAL FIELD

The present invention relates to the field of the storage of thermal energy in thermochemical form based on a reversible hydration/dehydration reaction of a solid.

### STATE OF THE ART

The recovery/redistribution of thermal energy on a site of heat production, or possibly on a site other than that of its recovery, is of great interest in addressing the problem of energy supply (electrical or thermal) that is adapted to the variations in demand over the course of the day and/or seasons. To be able to store excess thermal energy (waste heat) of solar origin or that produced by industrial installations using fossil energy or biomass to give it back later according to demand peaks would enable this problem to be solved. By way of example, in the field of concentrated thermal solar energy, the surplus heat produced in sunny hours can be stored and re-used at the end of the day.

Three approaches are emergent in the field of energy storage, these being sensible heat storage, latent heat storage and thermochemical storage.

Storage in the form of sensible energy relates to the use of a solid or liquid material whose temperature is made to vary without inducing a change of phase. The quantity of energy stored in the form of sensible heat is equal to:

Q=m(ΔT)Cₚ,

where m is the mass of the material, ΔT is the temperature difference in K and Cₚ is the heat capacity in J·K⁻¹·kg⁻¹.

Storage of sensible heat has the drawback that the material used generally has low energy density, which requires implementation of large volumes of said material. Such a system, on account of its bulk on the ground, is difficult to implement on industrial scale or in an urban environment.

Storage in the form of latent heat implements a phase change material (PCM), generally solid/liquid or liquid/vapor, with a small variation in its temperature. Thus, when the material is heated, it first of all accumulates sensible heat to reach its phase change temperature at which the calorific energy then only serves to provide the energy required for the phase change. Liquid-gas transformations are the most advantageous on account of their generally high latent heat but have implementation drawbacks linked to the change in volume associated with the evaporation of the liquid and also risks linked to the pressure drop phenomenon that can occur during gas cooling. Solid/liquid phase change materials are a good compromise between safety and storage performance.

These first two storage approaches in the form of sensible heat and latent heat generally require the implementation of efficient thermal insulation with however an inevitable loss over time of the stored heat.

The storage of heat in thermochemical form consists of using a reversible chemical reaction that is endothermic in one direction and exothermic in the other so as to store heat and then release it, respectively, according to need.

The storage may for example involve a sorption/desorption type reaction in which a compound (called adsorbate) is adsorbed on the surface of a solid material (called sorbent) or is absorbed inside a porous solid material with release of heat and, conversely, the adsorbed or absorbed solute is desorbed from the solid material in the presence of energy supply.

One class of reversible reaction that may be envisioned is a reversible dehydration/hydration reaction of a crystalline compound. Thus, the dehydration reaction, which may be conducted until the anhydrous form of the compound is obtained, requires a supply of thermal energy that can later be released when the dehydrated or partially dehydrated compound is placed back in contact with water or water vapor.

This form of heat storage has the advantage of being able to store energy over long periods, practically without loss and without recourse to a complex heat insulation system, provided the reaction products are separated and kept independently. In order for the method described above to be capable of industrialization, a material must be available which, in addition to having a high energy density, can undergo several hydration/dehydration cycles while maintaining its capacities for storage and restitution of heat.

Various solid materials have already been envisioned for thermochemical storage. For example, document FR 3 004 246 describes a method for storing heat using the Ca(OH)₂/CaO and Mg(OH)₂/MgO couple in solid form.

An object of the present invention is to provide a new storage method based on a reversible dehydration/hydration reaction of a solid material based on thorium or uranium, which are co-products of the uranium extraction and enrichment industry.

### SUMMARY OF THE INVENTION

The present invention thus relates to a thermochemical method for storing and releasing thermal energy by means of a compound in solid form of formula AOₓB_{y}.zH₂O, in which:
A is an element selected from uranium (U) and thorium (Th);
O is the element oxygen;
B is an anion or an oxoanion;
x is a number comprised between 0 and 4;
y is a number comprised between 0 and 2;
z is a number greater than 0 and less than or equal to 10;
   it being understood that at least one of x and y is different from 0 and that the compound of formula Th(SO₄)₂.xH₂O is excluded.

The method comprises the following successive steps:
(a) heating the compound to reach a temperature and for a period that are sufficient to at least partially dehydrate said compound;
(b) keeping the at least partially dehydrated compound away from humidity;
(c) placing the at least partially dehydrated compound in contact with water to release the thermal energy stored at step (a); and
(d) recovering the released thermal energy.

The method according to the invention may thus operate by alternation of charge and discharge cycles and is suitable for addressing the problem of the energy supply shifted in time and possibly in space.

The method according to the invention thus utilizes the hydration enthalpy of metal salts or of metal oxide salts to ensure the storage of thermal energy. The use of water, a non-toxic reagent, offers the possibility of being able to work in an open system (subject possibly to putting in place measures required to ensure that the aqueous discharges comply with the standards) and of presenting fewer health and environmental risks.

Thanks to the use of a compound as defined above, the method according to the invention has several other advantages which are:
storage with high energy density, for example at least 1 GJ/m³;
restitution of the heat which can be made at a practically constant temperature;
theoretically unlimited storage period;
possibility of operation within a temperature range for the storage which is compatible with industrial installations capable of providing the heat required for the dehydration reaction, such as power stations, refineries or for instance material processing plants;
exploitation in the short and medium term of stocks of depleted uranium and thorium while awaiting their future use as a raw material in fast-neutron nuclear reactors.

According to the invention, B is preferably selected from halide ions, the hydroxide ion and the sulfate ion.

In a preferred embodiment, the heat storage compound is selected from the compounds of formula:
UO₂B₂.zH₂O, B being selected from the ions F⁻, Br⁻ and Cl⁻,
AB₄.zH₂O, B being selected from the ions F⁻ and Br⁻,
UO₄.zH₂O,
UO₃.zH₂O, and
U(SO₄)y.zH₂O.

In a preferred embodiment, the thermochemical compound is selected from the compounds of formula: ThBr₄.10H₂O, UF₄.2H₂O, UF₄.2.5H₂O, UO₂F₂.4H₂O, UO₂F₂.1.6H₂O, U(SO₄)₂.4H₂O, UO₄.2H₂O, UO₃.2H₂O and UO₃.0.8-1H₂O.

According to one embodiment of implementation of the method, step (a) is carried out until dehydration of the compound is achieved so as to form the anhydrous or practically anhydrous compound. In the context of the invention, the term “practically anhydrous” is used to designate solid phases for which the structural water is comprised between 0<z<0.6 mol per mol of solid phase.

Depending on the thermochemical compound to be dehydrated, the heating temperature may be comprised between 50 and 500° C., preferably comprised between 80 and 350° C. The period is generally comprised between 15 minutes and 30 hours, preferably comprised between 30 minutes and 2 hours and will in particular depend upon the quantity of material and its shaping.

Preferably, step (c) of hydrating the partially or totally dehydrated compound is carried out in the presence of water vapor or by placing the dehydrated compound in contact with liquid water.

In the context of the invention, the heating of the compound (step (a)) for the purpose of dehydrating it may be carried out using any type of energy such as, for example, solar energy and/or thermal energy of industrial origin. For example, this energy may come from nuclear, coal or biomass power plants, refineries or material processing plants (cement factories, steel manufacture, incinerators). For example, the heating may consist of placing the thermochemical compound in contact with a stream of hot air, optionally dried or dehumidified.

The present invention also relates to a device for thermal energy storage which comprises:
an enclosure including at least one bed containing a compound as defined above;
at least one means for heating the bed; and
at least one means for evacuating the dehydration water.

The device according to the invention makes it possible to keep the at least partially dehydrated compound away from humidity until the moment when that compound is to be placed back in contact with water in order to give back the stored heat.

The device according to the invention may be designed so as to be transportable to a site at which the energy may be advantageously recovered.

According to one embodiment, the storage device according to the invention further comprises a means for distributing water in the enclosure and a means for evacuating the thermal energy released. In this reaction embodiment, the device is used both for storing and releasing the heat.

The thermochemical compound contained in the bed of material may take the form of a powder, beads, extrudates, or pellets.

When the compound is in powder form, the bed is preferably a fluid bed.

When the compound takes the form of beads, extrudates or pellets, the bed is preferably a fixed bed.

The method according to the invention may also implement the thermochemical compound deposited on a chemically inert and porous solid support, said support possibly being advantageously put into a form suitable for the type of reactor used (granules, beads, pellets, sticks, etc.). The material of the support may be organic, inorganic or composite (organic, inorganic). The material of the inorganic support is preferably selected from zeolites (natural or synthetic), aluminas, silicas, alumino-silicates, zirconium oxide, titanium oxide, silicon nitride and activated carbon. By way of non-limiting example, the material of the inorganic support is an α-alumina, a transition alumina (γ, δ, θ), a Kieselguhr silica SiO₂ or for instance a silica gel. Alternatively, the support may comprise a ceramic matrix based on carbon (vitreous carbon) or on silicon carbide (SiC).

The organic support material may be based on natural polymers (e.g. cellulose) or on synthetic polymers (e.g. polyurethane, polyesters, polyimides, high performance polymers). According to a preferred implementation, the organic polymer support takes the form of a foam.

The thermochemical compound dispersed on a support may be obtained by any method known to the person skilled in the art and in particular by the “dry” or “in excess” method of impregnating the support in a solution containing the precursor of the thermochemical compound, which is generally followed by a step of drying and/or calcining.

The inorganic support may have varied specific surface area and total porous volume ranging respectively from 20 to 500 m²/g and from 0.5 to 3 cm³/g.

When the support is of an organic polymer foam type, for example of polyurethane, it may have at least one of the following features:
volume cavities (i.e. pores or cells) of which the equivalent sphere diameter is comprised between 0.25 mm and 1.1 mm, preferably between 0.55 mm and 0.99 mm,
an internal specific surface area comprised between 4000 and 15000 m²/m³, preferably between 8000 and 10000 m²/m³, and
an apparent density (i.e. mass divided by apparent volume) measured in air comprised between 10 and 90 g/L, advantageously between 10 and 80 g/L, preferably between 15 and 45 g/L, such as between 20 and 45 g/L.

### DETAILED DESCRIPTION OF THE INVENTION

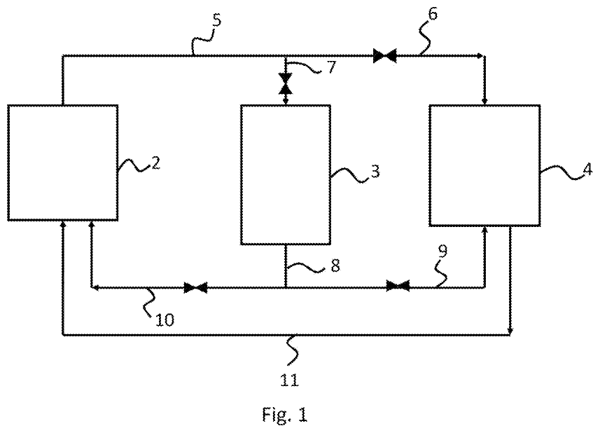

The other features and advantages of the invention will appear upon reading the following description, given solely by way of illustration and on a non-limiting basis, with reference to the drawings of FIGS. 1 to 6.

FIG. 1 is a block diagram of the principle of storage and discharge of heat implementing the method according to the invention.

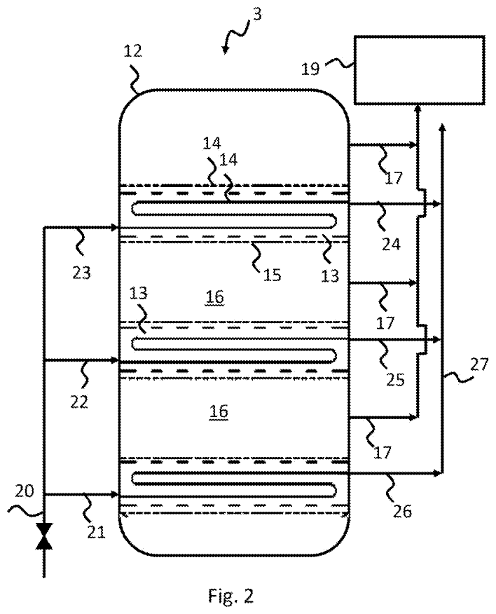

FIG. 2 is a representation in cross-section of a device for storing heat according to the invention.

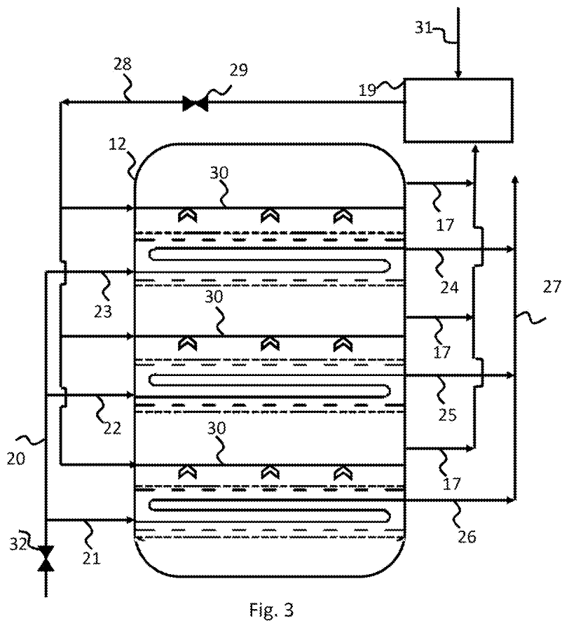

FIG. 3 is a representation in cross-section of another embodiment of a device for storing heat according to the invention which enables storage/discharge cycles to be carried out.

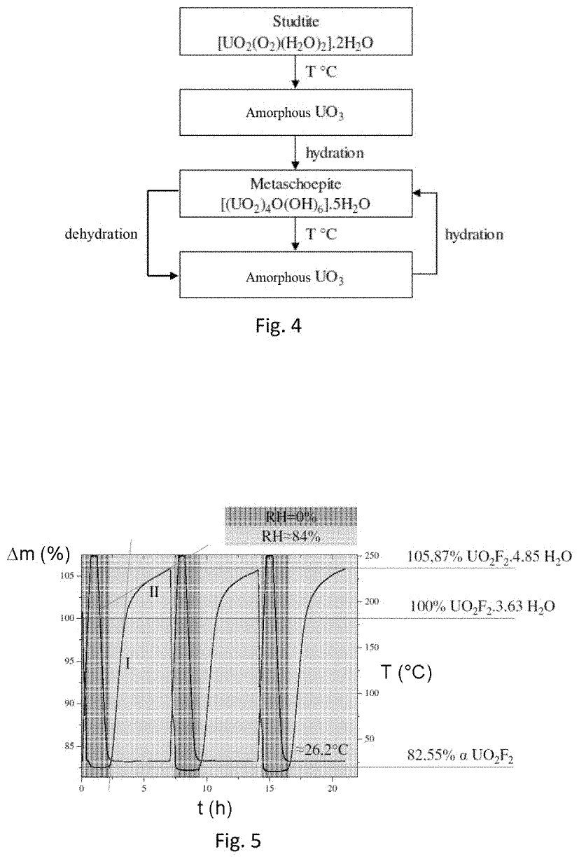

FIG. 4 is a block diagram summarizing the preferred synthesis route for providing metaschoepite (UO₃.2H₂O) which is then used as material for thermochemical storage.

FIG. 5 is a graph showing the variation in mass of the UO₂F₂.xH₂O powder (denoted Δm and expressed in %) during cycles of hydration and dehydration (as a function of time and temperature, respectively denoted t and T and expressed in h and in ° C., and of relative humidity denoted RH and expressed in %).

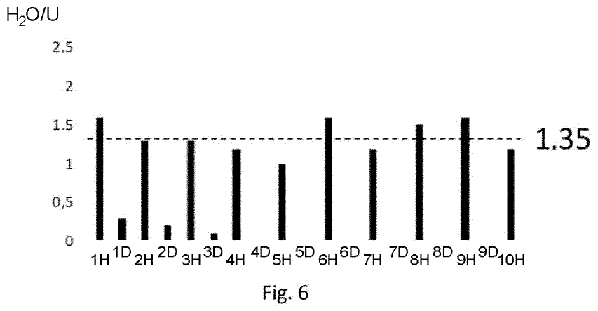

FIG. 6 is a graph showing the evolution of the degree of hydration of tablets of amorphous UO₃ obtained from studtite as a function of the number of cycles of hydration and dehydration.

Generally, similar elements are denoted by identical references in the figures.

In the following description, the term “thermochemical compound” designates any compound whatever its hydration state, including the compound in its anhydrous or practically anhydrous state.

The invention relates to a thermochemical method for recovery/restitution of calorific energy, involving a solid material capable of undergoing a reversible reaction of dehydration and of hydration.

The general principle of the method is described below in which the thermochemical compound according to the invention is designated by the letters “AB”.

In the charging phase, the thermal energy coming for example from a power plant or a factory, is supplied to a thermochemical reactor containing the compound of formula XY in order to dehydrate said compound XY and thereby form the compound X (solid) and the compound Y (here water). The products of the endothermic dehydration reaction are next stored separately for an indeterminate period and optionally at room temperature. Next, to give back the thermal energy stocked in the so-called restitution (or discharge) phase, the compounds X and Y are placed in contact in appropriate conditions of temperature and optionally of pressure in order for them to react to release the heat of reaction and thereby to regenerate the compound XY. This thermal energy given back is, for example, sent to an energy production unit capable of using the heat generated or is used in an urban heating application implementing, for example, a system comprising a primary water circuit and a secondary circuit supplying consumers with hot water, in which the water of the primary circuit is able to be heated by the heat given out by the thermochemical reaction so as to produce a flow of hot water of the primary circuit which is capable of exchanging heat with a stream of cold water of the secondary circuit.

According to the invention, the thermochemical compound used in the method is a hydrated metal oxide or salt capable of reacting according to the reaction:

AB.(m+n)H₂O↔AB.mH₂O+nH₂O

in which:
m is a number equal to or greater than 0; and
n is a number strictly greater than 0.

In the context of the present invention, the process of dehydrating the thermochemical compound (the storage phase) may lead to all the hydrated forms of said thermochemical compound and possibly to its anhydrous form. The thermochemical compound used in the present method must therefore be capable of binding to water according to an exothermic reaction, that is to say that the thermochemical compound, in its state of hydration considered, has a hydration enthalpy that is negative.

According to the invention, the thermochemical compound capable of stocking heat is a hydrated salt of general formula AOₓB_{y}.zH₂O, in which:
A is an element selected from uranium (U) and thorium (Th);
O is the element oxygen;
B is an anion or an oxoanion;
x is a number comprised between 0 and 4;
y is a number comprised between 0 and 2;
z is a number greater than 0 and less than or equal to 10;
   at least one of x and y being different from 0 and excluding compounds of formula Th(SO₄)₂.xH₂O.

Preferably, the thermochemical compound in its hydrated form, which is able to store heat by loss of water molecule, has an energy density of at least 1 GJ/m³, which is a value appreciably greater than that of water which is approximately 0.2 GJ/m³.

Preferably, the compound B is selected from halides, the hydroxide ion and the sulfate ion.

According to one embodiment, the thermochemical compound is a uranyl halide of formula UO₂B₂.zH₂O in which B is F⁻, Br⁻ or Cl⁻, with a preference for the uranyl difluoride UO₂F₂.zH₂O with z being equal to 1.6, 2 or 4.

The uranyl difluoride may be prepared, according to two main synthesis methods:
by a dry route, from uranium oxides on which hydrogen fluoride is made to act, thus leading to a weakly hydrated uranyl difluoride that contains 1 to 1.5% water;
by a wet route which consists of attacking uranium oxides or a uranyl salt with hydrofluoric acid solutions, or for instance hydrolysis of a uranium fluoride, leading to the crystallization of the dihydrate of uranyl difluoride.

Another synthesis method consists of the hydrolysis (or “quenching”) of uranium hexafluoride carried out by avoiding heating of the medium. The purification of the precipitate obtained is then carried out by successive recrystallizations until a U/F ratio equal to the stoichiometric amount is obtained. The hydrated compound can then undergo a drying step in order to form an anhydrous (or practically anhydrous) uranyl fluoride which, subsequently, can be rehydrated.

For a heat storage application, uranyl difluoride of formula UO₂F₂.4H₂O, which is capable of dehydrating reversibly into anhydrous α-UO₂F₂, is to be preferred. The dehydration reaction is preferably carried out by heating the solid at a temperature comprised between 150° C. and 250° C. under a stream of dry air. The hydration is carried out for example at room temperature under air with a relative humidity comprised between 30 and 90%, preferably comprised between 50 and 85%. Care will be taken not to exceed a relative humidity of 90% to avoid water being taken up too fast which would lead to deliquescence of the solid phase.

In the context of the invention, it is also possible to implement the dihydrate form of uranyl difluoride of formula UO₂F₂.2H₂O which is capable of being dehydrated by heating at a temperature comprised between 150° C. and 250° C. until the anhydrous phase α-UO₂F₂ is formed. The latter may be rehydrated in the same conditions as those described above.

In another embodiment, the thermochemical compound is a thorium or uranium tetrafluoride or tetrabromide hydrate satisfying the formula AB₄.zH₂O in which:
B is selected from the ions F⁻ and Br⁻,
A is one of the elements Th and U, and
z is greater than 0 and less than or equal to 10.

Thorium tetrabromide decahydrate (ThBr₄.10H₂O) can thus be selected as thermochemical compound satisfying the above formula. The latter can be obtained by evaporation of a thorium hydroxide solution in the presence of hydrobromic acid by heating as described in Wilson et al. (Structure of the Homoleptic Thorium(IV) Aqua Ion [Th(H₂O)₁₀]Br₄. Angew. Chemie Int. Ed. 46, 8043-8045 (2007)).

In the context of the invention, the thermochemical compound is based on uranium tetrafluoride which is a reaction intermediate in the manufacture of UF₆. For a thermochemical storage application, the compound of formula UF₄.2.5H₂O, preferably having a BET specific surface area of at least 1.4 m²/g, will in particular be used. The dehydration of UF₄.2.5H₂O to anhydrous UF₄ may be obtained by heating the compound at a temperature comprised between 200° C. and 250° C. and the hydration of said anhydrous compound may be carried out by placing it in contact either with water to which hydrofluoric acid has optionally been added, or in the presence of humidified air, for example having a relative humidity of at least 97%.

One route for obtaining uranium tetrafluoride is based on the hydrofluorination of uranium oxide UO₂, a method which is well-known to the person skilled in the art in the field of uranium conversion.

According to another preferred embodiment, the heat storage method uses a uranium salt of formula UO₃.2H₂O, which corresponds to the metaschoepite phase, which is capable of reversibly dehydrating into amorphous UO₃. According to the invention, using amorphous UO₃ is preferred since it has higher hydration kinetics than those of the crystallized phases (α, β, γ, δ, ϵ, ζ and η).

The UO₃.2H₂O metaschoepite is for example obtained by hydration of an amorphous UO₃ precursor. The latter can be synthesized by heating hexahydrated uranyl nitrate between 200° C. and 400° C. or a uranium(IV) oxalate between 150° C. and 300° C. This same phase may also be prepared by calcination of ammonium polyuranate between 350° C. and 600° C. or ammonium diuranate between 150° C. and 500° C. Another route for providing amorphous UO₃ consists of performing a heat treatment between 160° C. and 525° C. of a precipitate of uranyl peroxide of formula UO₂(O₂)(H₂O)₂.2H₂O (studtite).

FIG. 4 is a synoptic diagram summarizing the preferred synthesis route for providing the metaschoepite from studtite which is then used as thermochemical heat storage material. With reference to FIG. 4, the studtite is calcined at a temperature comprised between 250° C. and 300° C. so as to provide amorphous UO₃ which then undergoes a hydration step preferably carried out at a temperature comprised between 25° C. and 50° C., under air with a relative humidity greater than 70% leading to metaschoepite. Most preferably, the hydration is carried out at an initial temperature of approximately 30° C. in the presence of air of which the relative humidity is approximately 95%. Alternatively, the hydration of amorphous UO₃ (ex-studtite) can be carried out by placing the solid in contact with water vapor or liquid water.

The metaschoepite is used as material for thermochemical storage through dehydration/hydration cycles. For the subsequent dehydration steps, it is possible to operate by heating the metaschoepite to amorphous UO₃ at a temperature comprised between 300° C. and 350° C. and under gas flushing in particular to avoid forming the compound UO_{2.9}. As for hydration, it can be carried out in the conditions mentioned above, namely at a temperature of approximately 30° C. in the presence of air whose relative humidity is about 95%.

According to the invention, it is possible to restore the storage properties of the couple metaschoepite/amorphous UO₃ after several dehydration/hydration cycles by performing a partial oxidation of the amorphous UO₃ into UO₄.2H₂O during the hydration step. This oxidation concomitant with the hydration may be obtained by adding hydrogen peroxide H₂O₂ into the hydration medium or by flushing with ozone O₃. The amount of H₂O₂ that is provided is such that the H₂O₂/U ratio is generally comprised between 0.01 and 2 (mol/mol), this ratio preferably being equal to 0.25.

According to another embodiment, the amorphous UO₃/UO₃.0.8-1H₂O couple can be used in place of the amorphous UO₃/UO₃.2H₂O couple. This mode of implementation makes it possible to operate at higher temperature for the hydration step (T>50° C.) and thus to improve the kinetics, while maintaining an energy density (0.72-1.15 Gj/m³) close to that of UO₃.2H₂O (1.15-1.72 Gj/m³).

The storage method may also use the U0₄.2H₂O/amorphous UO₃ or UO₄.2H₂O/UO₃.0.8-1H₂O couples as thermochemical storage material, provided that a hydration in oxidizing environment is carried out in order to form uranium peroxide dihydrate (UO₄.2H₂O).

According to one embodiment, the thermochemical compound according to the invention may be implemented in a dispersed form on a refractory inorganic or organic support, that is to say, in the present case, which is not likely to degrade when it is subjected to the heat generated in operating the heat storage reactor.

It is thus possible to use inorganic support materials commonly used in the field of heterogeneous catalysis, such as zeolites (natural or synthetic), aluminas, silicas, alumino-silicates, magnesium oxide, zirconium oxide, titanium oxide, silicon nitride, silicon carbide or activated carbon. For example, the material of the inorganic support is an α-alumina, a transition alumina (γ, δ, θ), a Kieselguhr silica SiO₂, a silica or alumina gel that has undergone a hydrothermal treatment.

The support, when it is of inorganic nature, may be used in the form of beads, extrudates, pellets or irregular and non-spherical agglomerates, the specific form of which may result from a crushing step.

In the context of the invention, it is also possible to disperse the thermochemical compound on an organic support of natural polymer type (e.g. cellulose) or of synthetic polymer type (e.g. polyurethane). Preferably, the organic polymer support has the structure of a flexible or rigid foam. The support pieces, of various forms, may be obtained, for example, by cutting out or stamping from a block of foam or else directly by molding to the desired geometry on manufacturing said foam (injection molding technique).

The thermochemical compound dispersed on the organic or inorganic support is preferably obtained, in particular for reasons of ease of implementation, by a method of impregnating the support with a solution containing a precursor of the thermochemical compound, followed by a step of heat treatment of the impregnated support. The impregnating step is either an “excess” impregnation or a “dry” impregnation. By “dry” impregnation is meant impregnation with a volume of solution less than or at most equal to the total pore volume of the support, which may be measured by the mercury porosimetry technique according to the ASTM D4284 standard with a wetting angle of 140° or experimentally by weighing after soaking the support in water.

By way of example, a support on which the metaschoepite is dispersed may be prepared by means of the following steps:
(i) the support is placed in contact with an aqueous impregnation solution containing uranyl nitrate UO₂(NO₃)₂.nH₂O or uranium(IV) oxalate, the impregnation being carried out either “dry” or “in excess”;
(ii) possibly, the impregnated support is separated from the aqueous impregnation solution;
(iii) optionally, the impregnated support is placed in contact with a solution of hydrogen peroxide;
(iv) a heat treatment is carried out of the impregnated support obtained at the end of step (i), of step (ii) or of step (iii), under air, at a temperature comprised between 200 and 400° C. so as to form amorphous UO₃;
(v) the support containing the amorphous UO₃ from step (iv) is placed in contact with water so as to convert the amorphous UO₃ into UO₃.2H₂O.

According to another manner of preparing a support comprising dispersed metaschoepite, the impregnating step (i) is carried out from a uraniferous solution (for example uranyl nitrate UO₂(NO₃)₂) containing hydrogen peroxide H₂O₂ and optionally carbonates.

The synthesis of a thermochemical material comprising thorium tetrabromide (ThBr₄) dispersed on a support comprises, for example, a step of impregnating the support with a solution of thorium hydroxide and hydrobromic acid followed by a heat treatment of said impregnated support.

Another method of preparing a thermochemical material on a support, in particular configured for depositing uranyl fluoride within the support, consists of performing a step of impregnating the support with a precursor solution of the thermochemical compound followed by a step of in situ precipitation of the precursors by evaporating the solvent by heating. Alternatively, instead of the step of evaporating by heating, the precipitation of the thermochemical compound within the support matrix can be induced by placing said impregnated support in contact with a solvent (miscible with the solvent of the solution of precursors) but in which the precursors are less soluble.

According to the invention, the inorganic support may have the following features:
a specific surface area comprised between 20 and 500 m²/g (determined by the B.E.T method according to the ASTM D3663 standard as described in the work Rouquerol F.; Rouquerol J.; Singh K. “Adsorption by Powders & Porous Solids: Principle, methodology and applications”, Academic Press, 1999);
a total pore volume comprised between 0.5 and 3 cm³/g (measured by mercury porosimetry according to the ASTM D4284 standard with a wetting angle of 140°, as described in the same work).

When the support is a foam of an organic polymer, for example polyurethane, it may have at least one of the following features:
volume cavities (i.e. pores or cells) whose equivalent sphere diameter is comprised between 0.25 mm and 1.1 mm, preferably between 0.55 mm and 0.99 mm,
an internal specific surface area comprised between 4000 and 15000 m²/m³, preferably between 8000 and 10000 m²/m³, and
an apparent density (i.e. mass divided by apparent volume) measured in air comprised between 10 and 90 g/L, advantageously between 10 and 80 g/L, preferably between 15 and 45 g/L, such as between 20 and 45 g/L.

The method according to the invention may be coupled with any energy production method capable of using heat that must be collected for a time-shifted use.

FIG. 1 represents an example of a closed-loop heat storage system implementing the method according to the invention and using a heat exchange method by heat transfer fluid.

The heat storage system 1 comprises a thermal energy source 2, a heat storage unit 3 containing the thorium-based and/or uranium-based thermochemical compound and an energy production unit 4, which for example comprises a steam generator coupled to a steam turbine for producing electricity. A heat transfer fluid is made to circulate through a piping system 5, 6, 7, 8, 9, 10, 11 in order to convey the thermal energy between the different parts 2, 3, 4 of the heat storage system. The heat transfer fluid can thus circulate between the thermal energy source 2 and the heat storage unit 3 (via the pipes 5, 7, 8, 10), between the heat storage unit 3 and the energy production unit 4 (via the pipes 8, 9, 11) and lastly between the thermal energy source 2 and the energy production unit 4 (via the pipes 5, 6, 11).

The system 1 is thus configured to:
a. directly produce energy by making the heat transfer fluid circulate directly between the thermal energy source 2 and the energy production unit 4 (direct generation loop);
be. perform the storage of the excess thermal energy in the form of chemical energy in the thermochemical compound by making the heat transfer fluid circulate selectively between the thermal energy source 2 and the heat storage unit 3 (storage loop); and
c. generate energy from stored thermal energy (discharge process) by selective circulation of the heat transfer fluid between the heat storage unit 3 and the energy production unit 4 (restitution loop).

It is of course possible to operate the two circulation loops a. and b. described above simultaneously when at a given time the thermal energy generated by the source 2 exceeds energy needs. In this case, part of the heat transfer fluid circulates in the direct generation loop and another part of the heat transfer fluid circulates in the charging loop in order to store the excess heat.

Lastly, it is also possible to perform loops a. and c. concomitantly in order to meet a one-time peak in energy demand.

Any energy source capable of producing heat to at least partially dehydrate the thermochemical compound may be used, such as for example solar energy or thermal energy of industrial origin (refinery, nuclear power plant, steel industry, etc.).

The method of storing/giving back heat according to the invention comprises different steps which are detailed below, possibly with reference to the drawings of FIGS. 2 and 3.

Step (a) of the method consists in dehydrating the thermochemical compound by supplying it with the heat necessary to eliminate part of the water, or even all the water contained in the compound, but also to vaporize the water released by the dehydration reaction. The water in vapor form is evacuated from the reactor by a withdrawal means in order to isolate it from the dehydrated product. As indicated in FIG. 2, this step may be carried out in a thermochemical reactor 3 which comprises an enclosure 12 containing at least one bed 13 of thermal compound.

The supply of heat within the enclosure 12 to heat the bed 13 may be carried out by different methods known to the person skilled in the art and which may depend on the form in which the thermochemical compound is used. The thermochemical compound may take the form of a powder or the form of agglomerates, such as beads, extrudates or pellets, obtained from the powder by means of agglomeration techniques known to the person skilled in the art. The heat supply may be done via a device of heat exchanger type in which circulates a heat transfer fluid brought to temperature. Alternatively, bringing to temperature may be obtained by forced circulation of a hot gas which is placed in contact with the thermochemical compound.

The dehydration of the thermochemical compound is obtained by heating to a temperature which depends on the thermochemical compound and on its degree of hydration.

In the embodiment represented in FIG. 2, the reactor 12 comprises three fixed beds 13 containing the thermochemical compound which takes for example the form of agglomerates (of pellet or granule type) or of a powder. The fixed beds are contained by upper grid 14 and lower grid 15, the dimension of the openings of which is less than that of the agglomerates or of the powder so as to be able to retain the thermochemical compound while allowing passage of the water vapor formed in the dehydration reaction.

In the configuration of FIG. 2, a fixed bed 13 is separated from its closest neighbor or neighbors by a so-called collection zone 16, which is configured to collect the water vapor resulting from the dehydration reaction. The collection zone 16 is moreover equipped with a withdrawal means 17, for example a pipe, configured to evacuate the desorbed water so as to maintain the dehydrated thermochemical product isolated. The vaporized water from the collection zones 16 is optionally transferred by means of a pipe 18 to a condensing unit 19.

In the case where the collection zone is equipped with means for condensing the water released during the dehydration step, said zone is advantageously provided with a collector plate (not shown) to recover the dehydration water in liquid form, and said plate moreover being connected to the withdrawal means 17.

In the example of FIG. 2, the heat supply to the thermochemical compound is carried out by virtue of a heat exchange system composed of a set of pipes 20, 21, 22, 23 which runs through each of the fixed beds 13 and in which circulates a heat-transfer fluid. By way of example, the heat transfer fluid may be water vapor under pressure, a molten salt or for instance a synthetic oil. The cooled heat transfer fluid is evacuated from the enclosure 12 by the pipes 24, 25, 26, 27 and sent to a storage station (not shown).

When the thermochemical compound is in powder form, it is advantageous to perform the thermal exchange by directly injecting a hot gaseous fluid into the bed of thermochemical compound from the bottom of the thermochemical reactor. Preferably, the injection of the gas is carried out at a sufficient speed not only to fluidize (i.e. to place in suspension) the bed of particles and thereby ensure a good heat exchange but also to enable entrainment of the water produced during the dehydration reaction. By way of example, for the dehydration step, it is possible to use dinitrogen, dry or dehumidified air as fluidization gas.

Once the operation of heat storage has been completed, a thermochemical compound that is at least partly dehydrated is obtained. The thermochemical compound can then be stored (step (b)) away from humidity to be able to be used in a heat energy redistribution phase, which may be offset in time, to satisfy a high and one-time energy demand. The thermochemical compound may be either stored within the reactor 3 itself if the latter is moisture-tight, or evacuated to a dedicated storage container which must also be moisture-tight.

One embodiment for restitution of the stored energy, for example to ensure a heat production supplement in case of high one-time demand, is described with reference to FIG. 3 which implements a thermochemical reactor 3 similar to that of FIG. 2. The reactor 3 further comprises means for supplying water to rehydrate the dehydrated thermochemical compound. Thus water, for example in the form of atomized droplets or pre-heated vapor, is conveyed from the reservoir 19 containing for example water condensed during the dehydration step by the supply circuit 28 equipped with a valve 29 to the water distribution means 30. A heat supply 31 by any appropriate heating means may be provided to adjust the desired temperature of the water or vapor. As shown in FIG. 3, the distribution means 30 are preferably disposed above the beds 13.

The hydration heat is released and transferred to the heat transfer fluid which circulates in the pipes 20, 21, 22 and 23. The pipe 20 is also equipped with a valve 32 which makes it possible to regulate the flow rate of the heat transfer fluid which circulates within the thermochemical reactor. The heated heat transfer fluid is extracted from the reactor 3 by the pipes 24, 25, 26, 27 and sent, for example, to an energy production unit such as a thermal electrical power station or to an urban heating system which directly uses the heat. The release of heat is controlled by the humidity supplied to the thermochemical compound while the flow rate of the heat transfer fluid enables the temperature variation AT to be adjusted. It is possible to provide temperature detection means placed in the thermochemical reactor and on the heat transfer fluid evacuation pipe which are connected to a flow rate control system of the valves 29 and 32.

In the case where the thermochemical reactor used for the heat destocking step is of the fluidized bed type, the heat transfer/fluidization gas is sent directly from the bottom of the reactor at the same time as the hydration water which is distributed from the top of the reactor. For example, the heat transfer/fluidization gas is air or an inert gas which may optionally be pre-heated. An injection of ozone may also be envisioned if it is desired to perform hydration in an oxidizing medium in order to restore the storage capacities of the amorphous UO₃/UO₃.2H₂O or amorphous UO₃/UO₃.0.8-1H₂O couple.

### EXAMPLES

### Example 1 (UF₄.nH₂O)

The hydration study was carried out based on anhydrous UF₄ supplied by the company Orano, which was produced by hydrofluorination of uranium oxide UO₂. The compound contains UO₂ as an impurity (detected by X-ray diffraction (XRD) carried out on powder) and has a BET specific surface area of approximately 0.4 m²/g.

The anhydrous UF₄ powders are placed in contact with distilled water in ambient conditions and filtered after one month. The filtered powders are then air-dried and analyzed using TGA (thermogravimetric analysis) and XRD.

The X-ray diffraction reveals the formation of the UF₄.2.5H₂O phase and the TGA reveals a hydration at a level of 2.68 H₂O/U (mass loss of 13.32%, theoretical mass of UF₄.2.5H₂O of 12.54%). The theoretical densities of UF₄ and UF₄.2.5H₂O are 6.72 and 4.76 g/cm³ respectively, which represents a variation in volume of 38%. It is noted that the water loss from UF₄.2.5H₂O mainly takes place between 100 and 250° C. The first endothermic peak located around 115° C. corresponds to the loss of 0.5 molecule of free water. The second endothermic peak around 190° C. corresponds to the departure of the water molecules coordinated with the uranium. The total dehydration energy, distributed over two endothermic peaks, is approximately 1.44±23 GJ/m³.

Another hydration study, in milder conditions, was conducting by placing UF₄ powder in a thermostatically controlled cabinet at 25° C., and under relative humidity of approximately 97% controlled by virtue of a supersaturated solution of K₂SO₄. X-ray diffraction analysis reveals a change in phases after 125 days of hydration. The UF₄.2.5H₂O phase begins to crystallize without any hydration intermediates being observed. The hydration of the anhydrous phase is thus possible by a change in humidity, although the kinetics are slow.

### Example 2 (UO₂F₂.4H₂O)

The uranyl fluoride supplied by Orano having an isotype phase of γ-UO₂F₂.2H₂O was heated to 250° C. under a stream of dry air at a rate of 5° C./min. The sample is held at temperature for 30 min then cooled at the same rate. The experimental mass loss of 17.47°% reflects an initial composition close to UO₂F₂.3.63H₂O.

The dehydrated sample of UO₂F₂ is then maintained at a temperature of approximately 26° C. and under a relative humidity of approximately 84%. The variation in mass of the sample is tracked as a function of time. With reference to FIG. 5, it can be seen that the hydration of the dehydrated UO₂F₂ takes place in two steps with different kinetics:
a first step, at the rate of 3.43 H₂O/U/h, leads to a gain in mass corresponding to 4 molecules of H₂O/U,
a second, slower step of about 0.22 H₂O/U/h, leads to a final hydration amounting to 4.85 molecules of H₂O/U.

The experiment was repeated over three cycles and the results are fully reproducible as FIG. 5 indicates.

Another test was carried out with the compound α-UO₂F₂ obtained by heating UO₂F₂.3.43H₂O at 200° C. for 1 h. The anhydrous compound was next hydrated in air under ambient conditions. This hydration mode leads to the formation of β-UO₂F₂.1.6H₂O.

The theoretical densities of α-UO₂F₂ and of β-UO₂F₂.1.6H₂O are 6.38 and 4.77 g/cm³ respectively, which represents a variation in volume of 51%. The use of differential scanning calorimetry makes it possible to determine that the dehydration energy involved during the thermal decomposition of the β-UO₂F₂.1.6H₂O phase is about 0.97 GJ/m³.

### Example 3 (UO₃.nH₂O)

UO₃.2H₂O was synthesized by hydration of amorphous UO₃. For this, studtite, a uranyl peroxide of formula [(UO₂)(O₂)(H₂O)₂].2H₂O, is synthesized by precipitation. This precursor is next heated until it is transformed into amorphous UO₃ which is then hydrated into UO₃.2H₂O.

The precipitation of [(UO₂)(O₂)(H₂O)₂].2H₂O is carried out by dropwise addition of a solution of H₂O₂ 30% (VWR Chemicals) to a solution of UO₂(NO₃)₂.6H₂O at 0.5 M (H₂O₂/U=2 mol/mol). The solution is stirred for 3 min. The precipitate of pale yellow color is centrifuged at 4500 RPM for 5 min and washed several times with distilled water then with a solution of H₂O:ethanol (50:50 by volume) in order to eliminate the residual nitrates. The powder is next dried in air or in an oven at 30° C. before being calcined at 300° C. for 2 h under an argon stream with a temperature rise ramp of 5° C./min. The amorphous compound so obtained is shaped and then hydrated under a relative humidity RH of approximately 97% in the presence of a supersaturated solution of K₂SO₄ in a thermostatically controlled cabinet at 25° C. During hydration, it is noted that the compound progressively changes in color from brown to yellow, which characterizes metaschoepite.

Hydration/dehydration tests of ex-studtite UO₃ in pellet form were carried out in order to evaluate the influence of the shaping on the cyclability of the amorphous UO₃/UO₃ metaschoepite system.

Pellets of ex-studtite amorphous UO₃ (300 mg of powder) were formed using a hydraulic press and a mold of 8 mm diameter. A pressure of 200 MPa is applied to the powder for 5 min so as to provide, after demolding, pellets having a mass of about 300 mg, a diameter of 8 mm and a height of 1.32 mm.

The pellets are placed at 25° C. in static air at a relative humidity of about 97% so as to hydrate the ex-studtite amorphous UO₃ into metaschoepite.

The cyclability study is conducted over 10 cycles during which the hydration steps are carried out for 24 h under an air flow of 50 mL/min at around 30° C. and with a relative humidity RH comprised between 90-95% and the steps of dehydration by heating at 350° C. for 2 h under a stream of synthetic air. The average number of water molecules involved during the cycles determined from the masses of powder after each step is given in FIG. 6.

The densities of amorphous UO₃ and UO₃.2H₂O are approximately 7.11 and 4.97 g/cm³ respectively, representing a variation in volume of 38%. The use of differential scanning calorimetry (DSC) made it possible to determine the dehydration energy involved during the thermal decomposition of the UO₃.2H₂O phase. A first endothermic peak located below 200° C. corresponds to the departure of the interleaf water molecules (approximately 1.25 H₂O/U). The second peak located between 250 and 430° C. corresponds to the departure of the hydroxide groups in the form of water molecules (approximately 0.75 H₂O/U). Integration of the DSC curve makes it possible to estimate a total energy comprised between 233-347 J/g (i.e. 1.16-1.72 GJ/m³).

What is claimed is:

1. Thermochemical method for storing and releasing thermal energy by means of a compound in solid form of formula AOₓB_{y}.zH₂O, in which:
A is an element selected from uranium (U) and thorium (Th);
O is the element oxygen;
B is an anion or an oxoanion;
x is a number comprised between 0 and 4;
y is a number comprised between 0 and 2; and
z is a number greater than 0 and less than 10;
it being understood that at least one of x and y is different from 0 and that the compound of formula Th(SO₄)₂.xH₂O is excluded,
the method comprising the following successive steps:
(a) heating the compound to reach a temperature and for a period that are sufficient to at least partially dehydrate said compound;
(b) keeping the at least partially dehydrated compound away from humidity;
(c) placing the at least partially dehydrated compound in contact with water to release the thermal energy stored at step (a); and
(d) recovering the released thermal energy.

2. Method according to claim 1, in which step (a) is carried out until an anhydrous compound is obtained.

3. Method according to claim 1, in which step (c) is carried out in the presence of water vapor.

4. Method according to claim 1, in which the heating of step (a) is carried out using solar energy and/or thermal energy of industrial origin.

5. Method according to claim 4, in which the thermal energy is generated by power stations, refineries or material processing plants.

6. Thermal energy storage device comprising:
an enclosure including at least one bed containing a compound in solid form of formula AOₓB_{y}.zH₂O, in which:
A is an element selected from uranium (U) and thorium (Th);
O is the element oxygen;
B is an anion or an oxoanion;
x is a number comprised between 0 and 4;
y is a number comprised between 0 and 2;
z is a number greater than 0 and less than 10;
it being understood that at least one of x and y is different from 0 and that the compound of formula Th(SO₄)₂.xH₂O is excluded;
at least one heating means of the bed; and
at least one withdrawal means of the dehydration water.

7. Storage device according to claim 6, further comprising a means for distributing water and a means for evacuating the thermal energy released.

8. Device according to claim 6, in which the compound is in the form of a powder, a bead, an extrudate, or a pellet.

9. Device according to claim 6, in which the compound is deposited on an inorganic or organic support.

10. Device according to claim 8, in which the compound is in the form of a powder and the bed is a fluid bed.

11. Device according to claim 8, the compound being in the form of a bead, an extrudate or a pellet.

12. Method according to claim 1, in which B is selected from halide ions, the hydroxide ion and the sulfate ion.

13. Method according to claim 12, in which the compound is selected from:
UO₂B₂.zH₂O, B being selected from the F⁻, Br⁻ and Cl⁻;
AB₄.zH₂O, B being selected from F⁻ and Br⁻;
UO₃.zH₂O;
UO₄.zH₂O, and
U(SO₄)_{y}.zH₂O.

14. Method according to claim 13, in which the compound is selected from ThBr₄.10H₂O, UF₄.2H₂O, UF₄.2.5H₂O. UO₂F₂.4H₂O and UO₂F₂.1.6H₂O.

15. Method according to claim 13, in which the compound is selected from UO₄.2H₂O, UO₃.2H2O and UO₃.0.8-1H₂O.

16. Device according to claim 9, in which the bed is a fixed bed.

17. Device according to claim 6, in which B is selected from halide ions, the hydroxide ion and the sulfate ion.

18. Device according to claim 17, in which the compound is selected from:
UO₂B₂.zH₂O, B being selected from the F⁻, Br⁻ and Cl⁻;
AB₄.zH₂O, B being selected from F⁻ and Br⁻;
UO₃.zH₂O;
UO₄.zH₂O, and
U(SO₄)_{y}.zH₂O.

19. Device according to claim 18, in which the compound is selected from ThBr₄.10H₂O, UF₄.2H₂O, UF₄.2.5H₂O. UO₂F₂.4H₂O and UO₂F₂.1.6H₂O.

20. Device according to claim 18, in which the compound is selected from UO₄.2H₂O, UO₃.2H₂O and UO₃.0.8-1H₂O.
